(19) United States
(12) Patent Application Publication
(10) Pub. No.: US 2016/0233544 A1
(43) Pub. Date: Aug. 11, 2016

(54) LITHIUM SECONDARY BATTERY

(71) Applicant: SAMSUNG SDI CO., LTD., Yongin-si (KR)

(72) Inventors: Myunghoon Kim, Yongin-si (KR); Taehyun Bae, Yongin-si (KR); Aeran Kim, Yongin-si (KR); Woocheol Shin, Yongin-si (KR)

(21) Appl. No.: 14/749,329

(22) Filed: Jun. 24, 2015

(30) Foreign Application Priority Data
Feb. 6, 2015 (KR) 10-2015-0018862

(51) Int. Cl. H01M 10/0567; H01M 4/525; H01M 4/38; H01M 10/052

(52) U.S. Cl. CPC H01M 10/0567; H01M 10/052; H01M 4/525; H01M 4/386; H01M 2004/028

(57) ABSTRACT

A lithium secondary battery may be a high-capacity system that includes a silicon-based negative electrode active material. The high-capacity lithium secondary battery may have improved lifespan characteristics at high temperatures as well as at room temperature by including a fluorine-containing alkylene carbonate compound and a silylamide compound in an electrolyte thereof.

### CROSS-REFERENCE TO RELATED APPLICATION

This application claims priority to and the benefit of Korean Patent Application No. 10-2015-0018862, filed on Feb. 6, 2015, in the Korean Intellectual Property Office, the entire content of which is incorporated herein by reference.

### BACKGROUND

1. Field

One or more example embodiments relate to a lithium secondary battery.

2. Description of the Related Art

With the development of small high-tech devices such as digital cameras, mobile devices, laptops, and computers, the demand for a lithium secondary battery as an energy source has rapidly increased. In addition, with the spread of hybrid and plug-in electric vehicles (e.g., hybrid electric vehicle (HEV), plug-in hybrid electric vehicle (PHEV), and electric vehicle (EV)), denoted by the name of xEV where the “x” corresponds to the type of electric vehicle, the development of a safe lithium-ion battery of high capacity is ongoing.

With the demand for batteries of high capacity, electrode systems of various structures are being provided. For example, in order to provide high capacity, a silicon-based negative electrode active material may be used in a negative electrode. However, the silicon negative electrode may expand and contract during intercalation and deintercalation of lithium ions, respectively. As the charging-discharging cycle progresses, a crack may form in the silicon negative electrode due to the volume expansion and contraction. In the lithium secondary battery, a thick film may be formed (e.g., formed on an electrode) due to a formation of a new solid electrolyte interface (SEI) and electrolytic solution depletion may occur, resulting in a decrease in lifespan of the battery. Therefore, in order to resolve these problems, various elements that constitute a battery, not only an active material of high capacity, are being considered.

In addition, a lithium secondary battery having high energy density, such as a lithium secondary battery for electric vehicles or power storage, may be easily exposed to the outside and a high temperature environment, and the temperature of the battery may increase as a result of substantially instantaneous charging and discharging. Under such an environment, lifespan of the battery may be shortened, and the amount of energy stored therein may decrease.

### SUMMARY

One or more aspects of example embodiments include a high capacity lithium secondary battery having improved lifespan characteristics at room temperature and high temperatures. For example, aspects of example embodiments are directed toward an electrode system having high capacity and improved lifespan characteristics at high temperatures as well as room temperature.

Additional aspects will be set forth in part in the description which follows and, in part, will be apparent from the description, or may be learned by practice of the disclosed embodiments.

According to one or more example embodiments, a lithium secondary battery includes a positive electrode including a lithium nickel composite oxide; a negative electrode including a silicon-based negative electrode active material; and an electrolyte between the positive electrode and the negative electrode, the electrolyte including a fluorine-containing alkylene carbonate compound represented by Formula 1 and a silylamide compound represented by Formula 2:

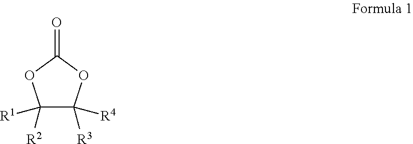

where in Formula 1,

R¹, R², R³, and R⁴ are each independently selected from a hydrogen atom, a fluorine atom, a C₁-C₆ alkyl group substituted or unsubstituted with a fluorine atom, a C₂-C₆ alkenyl group substituted or unsubstituted with a fluorine atom, and a C₂-C₆ alkynyl group substituted or unsubstituted with a fluorine atom, provided that at least one of R¹, R², R³, and R⁴ is a fluorine atom or a group substituted with at least one fluorine atom,

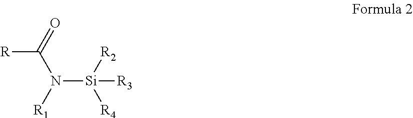

where in Formula 2,

R and R₁ are each independently selected from a hydrogen atom, a hydroxy group, a cyano group, —C(═O)Rₐ, —C(═O)ORₐ, —OC(═O)Rₐ, —OC(═O)(ORₐ), —NR_{b}R_{c}, a substituted or unsubstituted C₁-C₆ alkyl group, a substituted or unsubstituted C₁-C₆ alkoxy group, a substituted or unsubstituted C₂-C₆ alkenyl group, a substituted or unsubstituted C₂-C₆ alkynyl group, a substituted or unsubstituted C₃-C₁₂ cycloalkyl group, a substituted or unsubstituted C₆-C₂₀ aryl group, a substituted or unsubstituted C₆-C₂₀ aryloxy group, a substituted or unsubstituted C₆-C₂₀ heteroaryl group, and —ORₓ, where, Rₓ is a C₁-C₆ alkyl group or a C₆-C₂₀ aryl group;

R₂, R₃, and R₄ are each independently selected from a cyano group, —C(═O)Rₐ, —C(═O)ORₐ, —OC(═O)Rₐ, —OC(═O)(ORₐ), —NR_{b}R_{c}, a substituted or unsubstituted C₁-C₁₂ alkyl group, a substituted or unsubstituted C₁-C₁₂ alkoxy group, a substituted or unsubstituted C₂-C₁₂ alkenyl group, a substituted or unsubstituted C₂-C₁₂ alkynyl group, a substituted or unsubstituted C₃-C₁₂ cycloalkyl group, a substituted or unsubstituted C₆-C₁₂ aryl group, a substituted or unsubstituted C₆-C₁₂ aryloxy group, a substituted or unsubstituted C₆-C₁₂ heteroaryl group, and —OR_{y}, where, R_{y} is a C₁-C₁₂ alkyl group or a C₆-C₁₂ aryl group;

where Rₐ is selected from a hydrogen atom, an unsubstituted C₁-C₁₀ alkyl group, a C₁-C₁₀ alkyl group substituted with a halogen atom, an unsubstituted C₆-C₁₂ aryl group, a C₆-C₁₂ aryl group substituted with a halogen atom, an unsubstituted C₆-C₁₂ heteroaryl group, and a C₆-C₁₂ heteroaryl group substituted with a halogen atom; and

R_{b} and R_{c} are each independently selected from a hydrogen atom, an unsubstituted C₁-C₁₀ alkyl group, a C₁-C₁₀ alkyl group substituted with a halogen atom, unsubstituted C₂-C₁₀ alkenyl group, a C₂-C₁₀ alkenyl group substituted with a halogen atom, an unsubstituted C₃-C₁₂ cycloalkyl group, a C₃-C₁₂ cycloalkyl group substituted with a halogen atom, an unsubstituted C₆-C₁₂ aryl group, a C₆-C₁₂ aryl group substituted with a halogen atom, an unsubstituted C₆-C₁₂ heteroaryl group, a C₆-C₁₂ heteroaryl group substituted with a halogen atom, and —Si(R_{d})₃ (where, R_{d} is a C₁-C₁₀ alkyl group).

### BRIEF DESCRIPTION OF THE DRAWINGS

These and/or other aspects will become apparent and more readily appreciated from the following description of example embodiments, taken in conjunction with the accompanying drawings in which:

FIG. 1 is a schematic cross-sectional view illustrating a structure of a lithium battery according to an example embodiment;

FIG. 2 is a graph illustrating capacity retention ratio measurement results from the lithium secondary batteries in Example 1 and Comparative Examples 1 to 3 at room temperature (about 25° C.); and

FIG. 3 is a graph illustrating capacity retention ratio measurement results from the lithium secondary batteries in Example 1 and Comparative Examples 1 to 3 at a high temperature (about 45° C.).

### DETAILED DESCRIPTION

Reference will now be made in detail to example embodiments, examples of which are illustrated in the accompanying drawings, where like reference numerals refer to like elements throughout. In this regard, the present example embodiments may have different forms and should not be construed as being limited to the descriptions set forth herein. Accordingly, the example embodiments are merely described below, by referring to the figures, to explain aspects of the present description. Expressions such as “at least one of,” when preceding a list of elements, modify the entire list of elements and do not modify the individual elements of the list. Also, in the context of the present application, when a first element is referred to as being “on” a second element, it can be directly on the second element or be indirectly on the second element with one or more intervening elements interposed therebetween.

Hereinafter, example embodiments of the inventive concept will be described in more detail.

According to one or more example embodiments, a lithium secondary battery may include a positive electrode including a lithium nickel composite oxide; a negative electrode including a silicon-based negative electrode active material; and an electrolyte that is disposed between the positive electrode and the negative electrode and includes a fluorine-containing alkylene carbonate compound represented by Formula 1 and a silylamide compound represented by Formula 2:

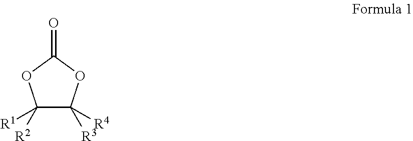

In Formula 1,

R¹, R², R³, and R⁴ may be each independently selected from a hydrogen atom, a fluorine atom, a C₁-C₆ alkyl group substituted or unsubstituted with a fluorine atom, a C₂-C₆ alkenyl group substituted or unsubstituted with a fluorine atom, and a C₂-C₆ alkynyl group substituted or unsubstituted with a fluorine atom, provided that at least one of R¹, R², R³, and R⁴ is a fluorine atom or a group substituted with at least one fluorine atom.

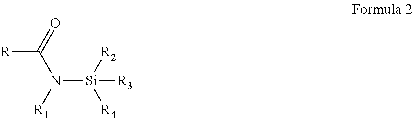

In Formula 2,

R and R₁ may be each independently selected from a hydrogen atom, a hydroxy group, a cyano group, —ORₓ (where, Rₓ may be a C₁-C₆ alkyl group or a C₆-C₂₀ aryl group), —C(═O)Rₐ, —C(═O)ORₐ, —OC(═O)Rₐ, —OC(═O)(ORₐ), —NR_{b}R_{c}, a substituted or unsubstituted C₁-C₆ alkyl group, a substituted or unsubstituted C₁-C₆ alkoxy group, a substituted or unsubstituted C₂-C₆ alkenyl group, a substituted or unsubstituted C₂-C₆ alkynyl group, a substituted or unsubstituted C₃-C₁₂ cycloalkyl group, a substituted or unsubstituted C₆-C₂₀ aryl group, a substituted or unsubstituted C₆-C₂₀ aryloxy group, and a substituted or unsubstituted C₆-C₂₀ heteroaryl group;

R₂, R₃, and R₄ may be each independently selected from a cyano group, —OR_{y} (where, R_{y} may be a C₁-C₁₂ alkyl group or a C₆-C₁₂ aryl group), —C(═O)Rₐ, —C(═O)ORₐ, —OC(═O)Rₐ, —OC(═O)(ORₐ), —NR_{b}R_{c}, a substituted or unsubstituted C₁-C₁₂ alkyl group, a substituted or unsubstituted C₁-C₁₂ alkoxy group, a substituted or unsubstituted C₂-C₁₂ alkenyl group, a substituted or unsubstituted C₂-C₁₂ alkynyl group, a substituted or unsubstituted C₃-C₁₂ cycloalkyl group, a substituted or unsubstituted C₆-C₁₂ aryl group, a substituted or unsubstituted C₆-C₁₂ aryloxy group, and a substituted or unsubstituted C₆-C₁₂ heteroaryl group;

where Rₐ may be selected from a hydrogen atom, an unsubstituted C₁-C₁₀ alkyl group, a C₁-C₁₀ alkyl group substituted with a halogen atom, an unsubstituted C₆-C₁₂ aryl group, a C₆-C₁₂ aryl group substituted with a halogen atom, an unsubstituted C₆-C₁₂ heteroaryl group, and a C₆-C₁₂ heteroaryl group substituted with a halogen atom; and

R_{b} and R_{c} may be each independently selected from a hydrogen atom, an unsubstituted C₁-C₁₀ alkyl group, a C₁-C₁₀ alkyl group substituted with a halogen atom, unsubstituted C₂-C₁₀ alkenyl group, a C₂-C₁₀ alkenyl group substituted with a halogen atom, an unsubstituted C₃-C₁₂ cycloalkyl group, a C₃-C₁₂ cycloalkyl group substituted with a halogen atom, an unsubstituted C₆-C₁₂ aryl group, a C₆-C₁₂ aryl group substituted with a halogen atom, an unsubstituted C₆-C₁₂ heteroaryl group, a C₆-C₁₂ heteroaryl group substituted with a halogen atom, and —Si(R_{d})₃ (where, R_{d} may be a C₁-C₁₀ alkyl group).

The positive electrode of the lithium secondary battery may include a lithium nickel composite oxide having high capacity as a positive electrode active material. In some embodiments, the lithium nickel composite oxide may include at least about 60 mol % of nickel based on the total moles of metal atoms, except lithium, of the lithium nickel composite oxide. For example, an amount of nickel included in the lithium nickel composite oxide may be at least about 70 mol %, or, for example, in a range of about 70 mol % to about 85 mol % based on the total moles of metal atoms, except lithium, of the lithium nickel composite oxide.

In this regard, the lithium secondary battery may have a high capacity by using a positive electrode active material including a large amount of nickel in the positive electrode.

In some embodiments, the lithium nickel composite oxide may be represented by Formula 3:

Liₐ(NiₓM′_{y}M″_{z})O₂ Formula 3

In Formula 3, M′ may be at least one element selected from Co, Mn, Ni, Al, Mg, and Ti, M″ may be at least one element selected from Ca, Mg, Al, Ti, Sr, Fe, Co, Mn, Ni, Cu, Zn, Y, Zr, Nb, B, and a combination thereof, 0<a≦1, 0.7≦x≦1, 0≦y≦0.3, 0≦z≦0.3, and x+y+z=1.

In some embodiments, the lithium nickel composite oxide may include a lithium nickel cobalt manganese oxide represented by Formula 4:

Liₐ(NiₓCo_{y}Mn_{z})O₂ Formula 4

In Formula 4, 0<a≦1, 0.7≦x≦1, 0≦y≦0.3, 0≦z≦0.3, and x+y+z=1.

In some embodiments, the lithium nickel composite oxide may include a lithium nickel cobalt aluminum oxide represented by Formula 5:

Liₐ(NiₓCo_{y}Al_{z})O₂ Formula 5

In Formula 5, 0<a≦1, 0.7≦x≦1, 0≦y≦0.3, 0≦z≦0.3, and x+y+z=1.

The lithium nickel composite oxide may have an average diameter (an average particle diameter) in a range of about 10 nm to about 100 μm or about 10 nm to about 50 μm. When the average diameter is within these ranges, the lithium battery may have improved physical properties. In some embodiments, the lithium nickel composite oxide may have a nano-particle shape (or size), having an average diameter (an average particle diameter), for example, of about 500 nm or less, about 200 nm or less, about 100 nm or less, about 50 nm or less, or about 20 nm or less. The nano-particle shape (or size) is suitable for providing high-rate discharging characteristics due to its contribution to an increase in the assembly density of the positive electrode plate. In addition, due to a decreased specific surface area of the nano-particle shape (or size), reactivity of the lithium nickel composite oxide with the electrolytic solution decreases, and thus, cycle characteristics may be improved.

The lithium nickel composite oxide may be formed of single particles. When primary particles agglomerate or are combined with each other, or when primary particles are combined with other active materials, secondary particles may be formed. The lithium nickel composite oxide may include primary particles and/or secondary particles.

The positive electrode may further include a compound that is generally used in the art as a positive electrode active material in a lithium battery.

The negative electrode may include a silicon-based negative electrode active material. The silicon-based negative electrode active material may provide high capacity.

As used herein, the term “silicon-based” refers to a material including at least about 50 wt % of silicon (Si), for example, an inclusion of at least about 60 wt %, 70 wt %, 80 wt %, or 90 wt % Si, or 100 wt % of Si, based on the total weight of the material.

The silicon-based negative electrode active material may include, for example, at least one selected from Si, SiOₓ (0<x<2), a Si—Z alloy (where Z may be an alkali metal, an alkali earth metal, a Group 13 to 16 element, a transition metal, a rare earth element, or combinations thereof, excluding Si), and a combination thereof. The element Z may be selected from Mg, Ca, Sr, Ba, Ra, Sc, Y, La, Ti, Zr, Hf, V, Nb, Ta, Cr, Mo, W, Tc, Re, Fe, Ru, Os, Co, Rh, Ir, Ni, Pd, Pt, Cu, Ag, Au, Zn, Cd, B, Ge, P, As, Sb, Bi, S, Se, Te, Po, and a combination thereof. In addition, the silicon-based negative electrode active material, such as Si, SiOx, or Si—Z alloy, may be substantially crystalline (including, for example, mono-crystalline and poly-crystalline), non-crystalline, or a combination thereof.

The silicon-based negative electrode active material may have a nano-structure having a dimension of at least one region thereof being less than about 500 nm, for example, less than about 200 nm, less than about 100 nm, less than about 50 nm, or less than about 20 nm. Examples of the nano-structure include nanoparticles, nanopowders, nanowires, nanorods, nanofibers, nanocrystals, nanodots, and nanoribbons.

Such silicon-based negative electrode active materials may be used alone, or in combination of two or more different kinds thereof.

The negative electrode may further include a compound that is generally used in the art as a negative electrode active material in a lithium battery.

An electrolyte may be between the positive electrode and the negative electrode.

In one embodiment, the electrolyte is a lithium salt-containing non-aqueous based electrolyte including a non-aqueous electrolytic solution and a lithium salt. In order to secure stability at a high temperature in a high capacity electrode system like the positive electrode and negative electrode described herein, the electrolyte may include a fluorine-containing alkylene carbonate compound and a silylamide compound as additives. When the fluorine-containing alkylene carbonate compound and the silylamide compound are included together in the electrolyte, the fluorine-containing alkylene carbonate compound and the silylamide compound may produce a synergistic effect on the improvement of the lifespan of the lithium secondary battery.

The fluorine-containing alkylene carbonate compound may be represented by Formula 1:

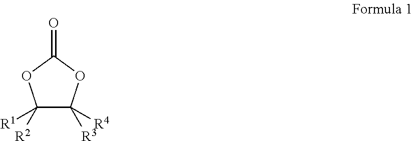

In Formula 1,

R¹, R², R³, and R⁴ may be each independently selected from a hydrogen atom, a fluorine atom, a C₁-C₆ alkyl group substituted or unsubstituted with a fluorine atom, a C₂-C₆ alkenyl group substituted or unsubstituted with a fluorine atom, and a C₂-C₆ alkynyl group substituted or unsubstituted with a fluorine atom, provided that at least one of R¹, R², R³, and R⁴ is a fluorine atom or a group substituted with at least one fluorine atom.

In some embodiments, R¹, R², R³, and R⁴ in Formula 1 may be selected from a hydrogen atom or a fluorine atom, provided that at least one of R¹, R², R³, and R⁴ is a fluorine atom.

The fluorine-containing alkylene carbonate compound may be, for example, monofluoroethylene carbonate, cis-4,5-difluoroethylene carbonate, trans-4,5-difluoroethylene carbonate, 4,4-difluoroethylene carbonate, trifluoroethylene carbonate, tetrafluoroethylene carbonate, or a mixture thereof. The compounds above may be prepared by direct fluorination of ethylene carbonate. Examples of difluorosubstituted ethylene carbonate include cis-trans-4,5-difluoroethylene carbonate, trans-4,5-difluoroethylene carbonate and 4,4-difluoroethylene carbonate, and these isomers may be separated by fractional distillation.

In some embodiments, R¹ in Formula 1 may be a C₁-C₃ alkyl group or a C₁-C₃ alkyl group substituted with at least one fluorine atom; and R², R³, and R⁴ may be a hydrogen atom or a fluorine atom, provided that at least one of R², R³, and R⁴ is a fluorine atom or R¹ is a C₁-C₃ alkyl group substituted with at least one fluorine atom. For example, R¹ may be methyl, ethyl, or vinyl.

Examples of the fluorine-containing alkylene carbonate compound include 4-fluoro-4-methyl-1,3-dioxolan-2-one, 4-fluoro-4-ethyl-1,3-dioxolan-2-one, 4-fluoro-5-methyl-1,3-dioxolan-2-one, 4-ethyl-4-fluoro-1,3-dioxolan-2-one, 5-ethyl-4-fluoro-4-ethyl-1,3-dioxolan-2-one, 4-fluoro-4,5-dimethyl-1,3-dioxolan-2-one, 4,5-difluoro-4-methyl-1,3-dioxolan-2-one, 4,4,5-trifluoro-5-methyl-1,3-dioxolan-2-one, and a mixture thereof.

In some embodiments, R¹ and R² in Formula 1 may be a C₁-C₃ alkyl group or a C₁-C₃ alkyl group substituted with at least one fluorine atom; and R³ and each may be a hydrogen atom or a fluorine atom, provided that at least one of R³ and R⁴ is a fluorine atom or at least one of R¹ and R² is a C₁-C₃ alkyl group substituted with at least one fluorine atom.

Additional examples of the fluorine-containing alkylene carbonate compound include 4-fluoro-5-(1-fluoroethyl)-1,3-dioxolan-2-one, 4-fluoro-5-(2-fluoroethyl)-1,3-dioxolan-2-one, 4-trifluoromethyl-4-methyl-1,3-dioxolan-2-one, 4-trifluoromethyl-4-methyl-5-fluoro-1,3-dioxolan-2-one, and 4-(2,2,2-trifluoroethyl)-4-methyl-5-fluoro-1,3-dioxolan-2-one.

The fluorine-containing alkylene carbonate compounds may be used alone, or in combination of two or more different kinds thereof.

The fluorine-containing alkylene carbonate compound may increase solubility of the lithium salt, which results in an increase of ion conductivity. As a solid electrolyte interface (SEI) layer on a surface of the negative electrode including the silicon-based negative electrode active material, a strong and thin LiF based protective film may be formed. The SEI layer may increase the amount of reversible Li ions and or reduce a reaction between the electrolytic solution and the negative electrode. The addition of the fluorine-containing alkylene carbonate compound may enable the electrolytic solution to form a relatively thin film (SEI layer) as compared to that formed from an electrolytic solution using another cyclic carbonate-based solvent that includes an alkyl group, but does not include fluorine. The addition of the fluorine-containing alkylene carbonate compound results in an increase of output of the lithium battery. On the other hand, cyclic carbonate without fluorine (cyclic carbonate that is not substituted with fluorine) may form a thick film that is oxygen rich. For example, when the cyclic carbonate without fluorine (cyclic carbonate that is not substituted with fluorine) is used in a silicon negative electrode, by-products formation on a surface of the negative electrode increases and causes a decrease in capacity, resulting in a decrease in lifespan.

The amount of the fluorine-containing alkylene carbonate compound in the electrolyte may be in a range of about 0.1 wt % to about 20 wt % based on the total weight of the electrolyte. In some embodiments, the amount of the fluorine-containing alkylene carbonate compound in the electrolyte may be in a range of about 1 wt % to about 15 wt %, or about 5 wt % to about 10 wt %, based on the total weight of the electrolyte. When the amount of the fluorine-containing alkylene carbonate compound is within these ranges, the lithium secondary battery may have improved lifespan characteristics at room temperature and high temperatures.

In addition, the electrolyte may include the fluorine-containing alkylene carbonate compound and a silylamide compound represented by Formula 2.

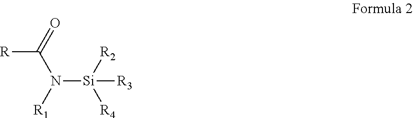

In Formula 2,

R and R₁ may be each independently selected from a hydrogen atom, a hydroxy group, a cyano group, —ORₓ (where, Rₓ may be a C₁-C₆ alkyl group or a C₆-C₂₀ aryl group), —C(═O)Rₐ, —C(═O)ORₐ, —OC(═O)Rₐ, —OC(═O)(ORₐ), —NR_{b}R_{c}, a substituted or unsubstituted C₁-C₆ alkyl group, a substituted or unsubstituted C₁-C₆ alkoxy group, a substituted or unsubstituted C₂-C₆ alkenyl group, a substituted or unsubstituted C₂-C₆ alkynyl group, a substituted or unsubstituted C₃-C₁₂ cycloalkyl group, a substituted or unsubstituted C₆-C₂₀ aryl group, a substituted or unsubstituted C₆-C₂₀ aryloxy group, and a substituted or unsubstituted C₆-C₂₀ heteroaryl group;

R₂, R₃, and R₄ may be each independently selected from a cyano group, —OR_{y} (where, R_{y} may be a C₁-C₁₂ alkyl group or a C₆-C₁₂ aryl group), —C(═O)Rₐ, —C(═O)ORₐ, —OC(═O)Rₐ, —OC(═O)(ORₐ), —NR_{b}R_{c}, a substituted or unsubstituted C₁-C₁₂ alkyl group, a substituted or unsubstituted C₁-C₁₂ alkoxy group, a substituted or unsubstituted C₂-C₁₂ alkenyl group, a substituted or unsubstituted C₂-C₁₂ alkynyl group, a substituted or unsubstituted C₃-C₁₂ cycloalkyl group, a substituted or unsubstituted C₆-C₁₂ aryl group, a substituted or unsubstituted C₆-C₁₂ aryloxy group, and a substituted or unsubstituted C₆-C₁₂ heteroaryl group;

where Rₐ may be selected from a hydrogen atom, an unsubstituted C₁-C₁₀ alkyl group, a C₁-C₁₀ alkyl group substituted with a halogen atom, an unsubstituted C₆-C₁₂ aryl group, a C₆-C₁₂ aryl group substituted with a halogen atom, an unsubstituted C₆-C₁₂ heteroaryl group, and a C₆-C₁₂ heteroaryl group substituted with a halogen atom; and

R_{b} and R_{c} may be each independently selected from a hydrogen atom, an unsubstituted C₁-C₁₀ alkyl group, a C₁-C₁₀ alkyl group substituted with a halogen atom, unsubstituted C₂-C₁₀ alkenyl group, a C₂-C₁₀ alkenyl group substituted with a halogen atom, an unsubstituted C₃-C₁₂ cycloalkyl group, a C₃-C₁₂ cycloalkyl group substituted with a halogen atom, an unsubstituted C₆-C₁₂ aryl group, a C₆-C₁₂ aryl group substituted with a halogen atom, an unsubstituted C₆-C₁₂ heteroaryl group, a C₆-C₁₂ heteroaryl group substituted with a halogen atom, and —Si(R_{d})₃ (where, R_{d} may be a C₁-C₁₀ alkyl group).

The following are descriptions of definitions of some of the substituents used herein.

The term “alkyl” group, as used herein, refers to a group derived from a completely saturated, branched or unbranched (e.g., a straight or linear chain) hydrocarbon.

Non-limiting examples of the “alkyl” group include methyl, ethyl, n-propyl, isopropyl, n-butyl, isobutyl, sec-butyl, t-butyl, iso-pentyl, neo-pentyl, iso-amyl, n-hexyl, 3-methylhexyl, 2,2-dimethylpentyl, 2,3-dimethylpentyl, and n-heptyl.

At least one hydrogen atom of the “alkyl” group may be substituted with a halogen atom, a C₁-C₂₀ alkyl group substituted with a halogen atom (e.g., CF₃, CHF₂, CH₂F, and CCl₃), a C₁-C₂₀ alkoxy group, a C₂-C₂₀ alkoxyalkyl group, a hydroxyl group, a nitro group, a cyano group, an amino group, an amidino group, a hydrazine group, a hydrazone group, a carboxylic acid group or a salt thereof, a sulfonyl group, a sulfamoyl group, a sulfonic acid group or a salt thereof, a phosphoric acid group or a salt thereof, a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₆-C₂₀ arylalkyl group, a C₆-C₂₀ heteroaryl group, a C₇-C₂₀ heteroarylalkyl group, a C₆-C₂₀ heteroaryloxy group, a C₆—O₂₀ heteroaryloxy alkyl group, or a C₆-C₂₀ heteroarylalkyl group.

The term “halogen atom,” as used herein, refers to fluorine, bromine, chlorine, or iodine.

The term “C₁-C₂₀ alkyl group substituted with a halogen atom,” as used herein, refers to a C₁-C₂₀ alkyl group substituted with at least one halogen group. Non-limiting examples thereof include a monohaloalkyl group, a dihaloalkyl group, and a polyhaloalkyl group, such as a perhaloalkyl group (e.g., an alkyl group in which each hydrogen atom has been replaced with a halogen atom).

As used herein, the term “monohaloalkyl group” may refer to an alkyl group including iodine, bromine, chlorine, or fluorine. As used herein, the terms “dihaloalkyl group” and “polyhaloalkyl group” refer to an alkyl group having two or more halogen atoms (e.g., iodine, bromine, chlorine, and/or fluorine) that are the same or different from each other.

The term “alkoxy” group, as used herein, may be represented by alkyl-O—, where the term “alkyl” has the same meaning as described above. Non-limiting examples of the alkoxy group include methoxy, ethoxy, propoxy, 2-propoxy, butoxy, tert-butoxy, pentyloxy, hexyloxy, cyclopropoxy, and cyclohexyloxy. At least one hydrogen atom of the alkoxy group may be substituted with the same substituents as described with respect to the alkyl group.

The term “alkoxyalkyl” group, as used herein, refers to an alkyl group substituted with the above-described alkoxy group. At least one hydrogen atom of the alkoxyalkyl group may be substituted with the same substituents as described with respect to the alkyl group. Likewise, the term “alkoxyalkyl,” as used herein, may refer to a substituted alkoxyalkyl moiety.

The term “alkenyl” group, as used herein, refers to a group derived from a branched or unbranched hydrocarbon having at least one carbon-carbon double bond. Non-limiting examples of the alkenyl group include vinyl, aryl, butenyl, isopropenyl, and isobutenyl. At least one hydrogen atom of the alkenyl group may be substituted with the same substituents as described with respect to the alkyl group.

The term “alkynyl” group, as used herein, refers to a group derived from a branched or unbranched hydrocarbon having at least one carbon-carbon triple bonds. Non-limiting examples of the alkynyl group include ethynyl, butynyl, iso-butynyl, and iso-propynyl.

At least one hydrogen atom of the “alkynyl group” may be substituted with the same substituents as described with respect to the alkyl group.

The term “aryl” group, as used herein, which may be used alone or in combination with other terms, refers to an aromatic hydrocarbon containing at least one ring.

The term “aryl” group, as used herein, includes a group having an aromatic ring fused to at least one cycloalkyl ring.

Non-limiting examples of the “aryl” group include phenyl, naphthyl, and tetrahydronaphthyl.

At least one hydrogen atom of the “aryl” group may be substituted with the same substituents as described with respect to the alkyl group.

The term “arylalkyl” group, as used herein, refers to an alkyl group substituted with an aryl group. Examples of the “arylalkyl” group include benzyl and phenyl-CH₂CH₂—.

The term “aryloxy” group, as used herein, may be represented by —O-aryl, and an example thereof is phenoxy. At least one hydrogen atom of the “aryloxy” group may be substituted with the same substituents as described with respect to the alkyl group.

As used herein, the term “heteroaryl” group refers to an aromatic monocyclic or bicyclic organic compound including at least one heteroatom selected from nitrogen (N), oxygen (O), phosphorous (P), and sulfur (S), where the rest of the cyclic atoms are all carbon atoms (e.g., the remaining ring-forming atoms of the ring or rings are all carbon). The heteroaryl group may include, for example, one to five heteroatoms, and in some embodiments, may include a five- to ten-membered ring. In the heteroaryl group, S or N may be present in various oxidized forms.

At least one hydrogen atom of the heteroaryl group may be substituted with the same substituents as described with respect to the alkyl group.

The term “heteroarylalkyl” group, as used herein, refers to an alkyl group substituted with a heteroaryl group.

The term “heteroaryloxy” group, as used herein, refers to an —O-heteroaryl moiety. At least one hydrogen atom of the heteroaryloxy group may be substituted with the same substituents as described with respect to the alkyl group.

The term “heteroaryloxyalkyl” group, as used herein, refers to an alkyl group substituted with a heteroaryloxy group. At least one hydrogen atom of the heteroaryloxy group may be substituted with the same substituents as described with respect to the alkyl group.

The term “sulfonyl,” as used herein, refers to R″—SO₂—, where R″ may be a hydrogen, alkyl, aryl, heteroaryl, arylalkyl, heteroarylalkyl, alkoxy, aryloxy, cycloalkyl, or hetero cyclo alkyl group.

The term “sulfamonyl” group, as used herein, refers to H₂NS(O₂)—, alkyl-NHS(O₂)—, (alkyl)₂NS(O₂)-aryl-NHS(O₂)—, alkyl(aryl)-NS(O₂)—, (aryl)₂NS(O)₂, heteroaryl-NHS(O₂)—, (aryl-alkyl)-NHS(O₂)—, or (heteroaryl-alkyl)-NHS(O₂)—.

At least one hydrogen atom of the sulfamonyl group may be substituted with the same substituents as described with respect to the alkyl group.

The term “amino” group, as used herein, refers to a case where a nitrogen atom is covalently bonded to at least one carbon or heteroatom. Examples of the amino group include —NH₂ and a substituted moiety thereof. In addition, the amino group may include “alkylamino” in which a nitrogen atom is bonded to at least one additional alkyl group, “arylamino” in which a nitrogen atom is bonded to at least one aryl group, and “diarylamino” in which a nitrogen atom is bonded to at least two aryl groups, where the aryl groups are independently selected.

In some embodiments, in Formula 2, R and R₁ may be each independently selected from a C₁-C₆ alkyl group and a C₁-C₆ alkyl group substituted with at least one halogen atom; and R₂, R₃, and R₄ may be each independently selected from a C₁-C₁₂ alkyl group, a C₁-C₁₂ alkyl group substituted with at least one halogen atom, a C₂-C₁₂ alkenyl group, and a C₂-C₁₂ alkenyl group substituted with at least one halogen atom.

In some embodiments, at least one selected from R, R₁, R₂, R₃, and R₄ may include an alkenyl group.

In some embodiments, at least one selected from R, R₁, R₂, R₃, and R₄ may be an electron-withdrawing group, for example, a group that includes a group substituted with electron-withdrawing moieties, such as halogens, or another group substituted with electron-withdrawing moieties.

In some embodiments, at least one selected from R, R₁, R₂, R₃, and R₄ may be a group substituted with a fluorine atom. At least one selected from R, R₁, R₂, R₃, and R₄ may be a perfluorinated alkyl group (e.g., an alkyl group in which each hydrogen atom has been replaced with a fluorine atom). At least one selected from R, R₁, R₂, R₃, and R₄ may be selected from a C₁-C₃ alkyl group substituted with at least one halogen atom, and a C₁-C₃ alkenyl group substituted with at least one halogen atom.

In some embodiments, the silylamide compound may include at least one selected from Compounds 1 to 4 below:

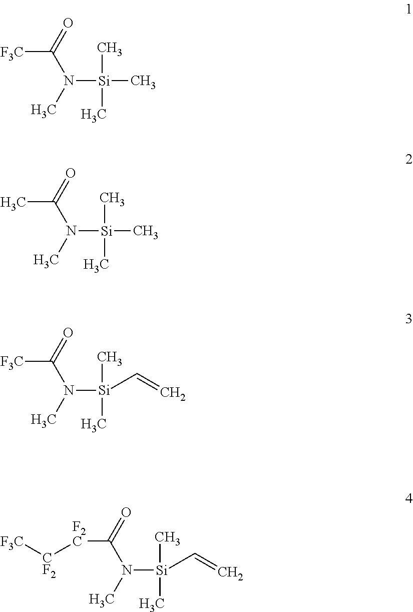

The silylamide compound together with the fluorine-containing alkylene carbonate compound may contribute to the improvement of lifespan characteristics of the lithium secondary battery. For example, although the present application is not limited by any particular mechanism or theory, it is believed that when the silylamide compound and the fluorine-containing alkylene carbonate compound are used in a silicon negative electrode, the bond between a nitrogen and a silicon in the silylamide compound may break down (decompose). In other words, the compounds may serve as a HF scavenger. It is believed that, due to this reason, the silylamide compound and the fluorine-containing alkylene carbonate compound may produce a synergistic effect on improvement of the lifespan of a lithium secondary battery. In addition, a material containing a trimethylsilyl group may increase the irreversibility of a negative electrode, and this may contribute to the synergistic effect on improvement of the lifespan of a lithium secondary battery.

The amount of the silylamide compound in the electrolyte may be in a range of about 0.01 wt % to about 10 wt % based on the total weight of the electrolyte. In some embodiments, the amount of the silylamide compound may be in a range of about 0.05 wt % to about 5 wt % based on the total weight of the electrolyte, or, for example, about 0.1 wt % to about 1 wt %. When the silylamide compound is used within these ranges, lifespan characteristics of a lithium secondary battery may be improved.

In addition, the electrolyte may optionally include other additives as well as the fluorine-containing alkylene carbonate compound and the silylamide compound.

Examples of the other additives that may be added include LiBF4, tris(trimethylsilyl) borate (TMSB), tris(trimethylsilyl) phosphate (TMSPa), lithium bis(oxalato)borate (LiBOB), lithium difluoro(oxalato)borate (LiFOB), vinyl carbonate (VC), propane sultone (PS), succinonitrile (SN), a silane compound having a functional group able to form a siloxane bond (e.g., acryl, amino, epoxy, methoxy, ethoxy, or vinyl), and a silazane compound such as hexamethyldisilazane. The additives may be used alone or in a combination or mixture of at least two thereof.

The amount of the other additives in the electrolyte may be in a range of about 0.01 wt % to about 10 wt % based on the total weight of the electrolyte in order to form a more stable SEI film. For example, the amount of the other additives may be in a range of about 0.05 wt % to about 10 wt %, about 0.1 to about 5 wt %, or about 0.5 to about 4 wt % based on the total weight of the electrolyte. However, the amount of the other additives is not particularly limited unless the additives significantly hinder improvement in capacity retention rate of a lithium battery that includes the electrolyte.

The non-aqueous electrolytic solution used in the electrolyte may serve as a migration medium of ions involved in electrochemical reactions of the battery.

The non-aqueous electrolytic solution may be a carbonate compound, an ester-based compound, an ether-based compound, a ketone-based compound, an alcohol-based compound, an aprotic solvent, or a combination or mixture thereof.

The carbonate compound may be a chain carbonate compound, a cyclic carbonate compound, or a combination or mixture thereof.

Examples of the chain carbonate compound include diethyl carbonate (DEC), dimethyl carbonate (DMC), dipropyl carbonate (DPC), methylpropyl carbonate (MPC), ethylpropylcarbonate (EPC), methylethyl carbonate (MEC), and a combination or mixture thereof.

Examples of the cyclic carbonate compound include ethylene carbonate (EC), propylene carbonate (PC), butylene carbonate (BC), vinylethylene carbonate (VEC), and a combination or mixture thereof.

The carbonate compound may include a combination or mixture of the chain carbonate compound and the cyclic carbonate compound. A mixture ratio of the chain carbonate compound to the cyclic carbonate compound may be in a range of about 15:85 to about 40:60 by volume.

Examples of the ester-based compound include methyl acetate, acetate, n-propyl acetate, dimethyl acetate, methyl propionate, ethyl propionate, γ-butyrolactone, decanolide, valerolactone, mevalonolactone, and caprolactone. Examples of the ether-based compound include dibutyl ether, tetraglyme, diglyme, dimethoxyethane, 2-methyltetrahydrofuran, and tetrahydrofuran. An example of the ketone compound is cyclohexanone. Examples of the alcohol-based compound include ethyl alcohol and isopropyl alcohol.

Examples of the aprotic solvent include dimethylsulfoxide, 1,2-dioxolane, sulfolane, methylsulfolane, 1,3-dimethyl-2-imidazolidinone, N-methy-2-pyrrolidinone, formamide, dimethylformamide, acetonitrile, nitromethane, trimethyl phosphate, triethyl phosphate, trioctyl phosphate, and phosphate triester.

The non-aqueous electrolyte solution may be utilized alone or in a combination or mixture of at least two kinds of the non-aqueous electrolyte solutions. In the latter case, a mixing ratio of the at least two kinds of non-aqueous electrolyte solutions may be appropriately adjusted depending on a desired performance of the battery.

The lithium salt included in the electrolyte may serve as a lithium ion source in the battery to enable normal operation of the lithium battery. The lithium salt may be any suitable lithium salt that is generally utilized for lithium batteries. Examples of the lithium salt for the non-aqueous electrolyte include LiCl, LiBr, LiI, LiClO₄, LiB₁₀Cl₁₀, LiPF₆, CF₃SO₃Li, CH₃SO₃Li, C₄F₃SO₃Li, (CF₃SO₂)₂NLi, LiN(CₓF₂ₓ₊₁SO₂)(C_{y}F_{2+y}SO₂) (where x and y are natural numbers), CF₃CO₂Li, LiAsF₆, LiSbF₆, LiAlCl₄, LiAlF₄, lithium chloro borate, lower aliphatic carboxylic acid lithium, lithium tetraphenylborate, lithium imide, and a combination or mixture thereof.

The lithium salt may be utilized in a concentration in a range of about 0.1 M to about 2.0 M in the electrolyte to improve the performance of the lithium battery. When the concentration of the lithium salt is within this range, the electrolyte may have appropriate or suitable conductivity and viscosity for improved performance, and may improve the mobility of lithium ions.

The lithium battery having such a structure may be manufactured by using a manufacturing method that is generally available in the art, and therefore, further description regarding the manufacturing method will not be provided here.

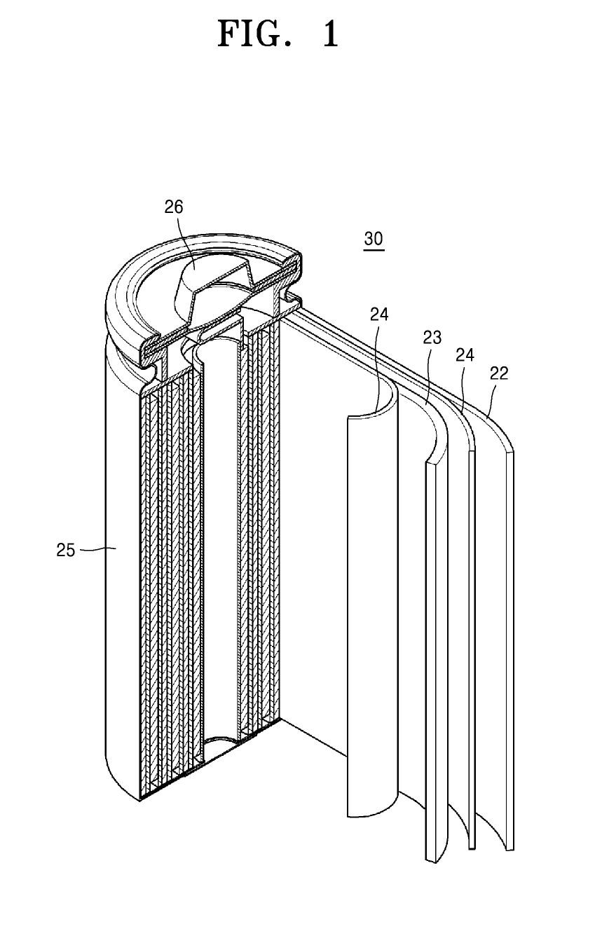

FIG. 1 is a schematic cross-sectional view illustrating a structure of a lithium battery according to an example embodiment.

Referring to FIG. 1, the lithium battery 30 includes a positive electrode 23, a negative electrode 22, and a separator 24 disposed between the positive electrode 23 and the negative electrode 22. The positive electrode 23, the negative electrode 22, and the separator 24 may be wound or folded to be accommodated in a battery case 25. Then, the battery case 25 is filled with an electrolyte and sealed by a sealing member 26, thereby completing the manufacture of the lithium battery 30. The battery case 25 may be a cylindrical type (or kind), a rectangular type (or kind), or a thin-film type (or kind). For example, the lithium battery 30 may be a lithium ion battery.

The positive electrode 23 includes a positive electrode current collector, and a positive electrode active material layer disposed on the positive electrode current collector.

The positive electrode current collector may have a thickness of about 3 μm to about 500 μm. The positive electrode current collector is not particularly limited, and may be any suitable material as long as it has a suitable conductivity without causing chemical changes in the battery. Examples of the positive electrode current collector include copper, stainless steel, aluminum, nickel, titanium, sintered carbon, copper or stainless steel that is surface-treated with carbon, nickel, titanium or silver, and aluminum-cadmium alloys. In addition, the positive electrode current collector may be processed to have fine bumps on surfaces thereof so as to enhance binding strength of the positive electrode current collector to a cathode active material (a positive electrode active material), and may be used in various suitable forms including films, sheets, foils, nets, porous structures, foams, and non-woven fabrics.

The positive electrode active material layer may include a positive electrode active material, a binder, and, optionally, a conducting agent.

The positive electrode active material may include a lithium nickel composite oxide. The positive electrode active material layer may further include any other suitable positive electrode active material generally available in the art, as well as the lithium nickel composite oxide.

The other positive electrode active material is not particularly limited, and may be any suitable positive electrode active material that is generally used in the art, provided that the other positive electrode active material is different from the lithium nickel composite oxide. In some embodiments, the other positive electrode active material may be a compound represented by one of LiₐA_{1-b}B_{b}D₂ (where, 0.90≦a≦1, and 0≦b≦0.5); LiₐE_{1-b}B_{b}O_{2-c}D_{c} (where, 0.90≦a≦1, 0≦b≦0.5, and 0≦c≦0.05); LiE_{2-b}B_{b}O_{4-c}D_{c} (where, 0≦b≦0.5, and 0≦c≦0.05); LiₐNi_{1-b-c}Co_{b}B_{c}Dₐ (where, 0.90≦a≦1, 0≦b≦0.5, 0≦c≦0.05, and 0<α≦2); LiₐNi_{1-b-c}Co_{b}B_{c}O₂₋ₐFₐ (where, 0.90≦a≦1, 0≦b≦0.5, 0≦c≦0.05, and 0<α<2); LiₐNi_{1-b-c}Co_{b}B_{c}O₂₋ₐF₂ (where, 0.90≦a≦1, 0≦b≦0.5, 0≦c≦0.05, and 0<α<2); LiₐNi_{1-b-c}Mn_{b}B_{c}Dₐ (where, 0.90≦a≦1, 0≦b≦0.5, 0≦c≦0.05, and 0<α≦2); LiₐNi_{1-b-c}Mn_{b}B_{c}O_{2-α}F_{α} (where, 0.90≦a≦1, 0≦b≦0.5, 0≦c≦0.05, and 0<α<2); LiₐNi_{1-b-c}Mn_{b}B_{c}O_{2-α}F₂ (where, 0.90≦a≦1, 0≦b≦0.5, 0≦c≦0.05, and 0<α<2); LiₐNi_{b}E_{c}G_{d}O₂ (where, 0.90≦a≦1, 0≦b≦0.9, 0≦c≦0.5, and 0.001≦d≦0.1.); LiₐNi_{b}Co_{c}Mn_{d}GₑO₂ (where, 0.90≦a≦1, 0≦b≦0.9, 0≦c≦0.5, 0≦d≦0.5, and 0.001≦e≦0.1.); LiₐNiG_{b}O₂ (where, 0.90≦a≦1, and 0.001≦b≦0.1.); LiₐCoG_{b}O₂ (where, 0.90≦a≦1, and 0.001≦b≦0.1.); LiₐMnG_{b}O₂ (where, 0.90≦a≦1, and 0.001≦b≦0.1.); LiₐMn₂G_{b}O₄ (where, 0.90≦a≦1, and 0.001≦b≦0.1.); QO₂; QS₂; LiQS₂; V₂O₅; LiV₂O₅; LiIO₂; LiNiVO₄; Li_{(3-f)}J₂(PO₄)₃ (where, 0≦f≦2); Li_{(3-f)}Fe₂(PO₄)₃ (where, 0≦f≦2); and LiFePO₄.

In the formulae above, A is nickel (Ni), cobalt (Co), manganese (Mn), or a combination thereof; B is aluminum (Al), nickel (Ni), cobalt (Co), manganese (Mn), chromium (Cr), iron (Fe), magnesium (Mg), strontium (Sr), vanadium (V), a rare earth element, or a combination thereof; D is oxygen (O), fluorine (F), sulfur (S), phosphorus (P), or a combination thereof; E is cobalt (Co), manganese (Mn), or a combination thereof; F is fluorine (F), sulfur (S), phosphorus (P), or a combination thereof; G is aluminum (Al), chromium (Cr), manganese (Mn), iron (Fe), magnesium (Mg), lanthanum (La), cerium (Ce), strontium (Sr), vanadium (V), or a combination thereof; Q is titanium (Ti), molybdenum (Mo), manganese (Mn), or a combination thereof; I is chromium (Cr), vanadium (V), iron (Fe), scandium (Sc), yttrium (Y), or a combination thereof; and J is vanadium (V), chromium (Cr), manganese (Mn), cobalt (Co), nickel (Ni), copper (Cu), or a combination thereof.

Examples of the other positive electrode active material include LiCoO₂, LiMnₓO₂ₓ (where, x=1, 2), LiNi₁₋ₓMnₓO₂ₓ (where, 0<x<1), LiNi_{1-x-y}CoₓMn_{y}O₂ (where 0≦x≦0.5, and 0≦y≦0.5), and FePO₄.

The compounds listed above as positive electrode active materials may have a surface coating layer (hereinafter, “coating layer”). Alternatively, a mixture of a compound without having a coating layer and a compound having a coating layer, the compounds being selected from the compounds listed above, may be used. The coating layer may include at least one compound of a coating element selected from an oxide, a hydroxide, an oxyhydroxide, an oxycarbonate, and a hydroxycarbonate of the coating element. The compounds for the coating layer may be amorphous or crystalline.

The coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or mixtures thereof. The coating layer may be formed by using any suitable method that does not adversely affect the physical properties of the positive electrode active material when a compound of the coating element is used. For example, the coating layer may be formed by using a spray coating method, or a dipping method. The methods of forming the coating layer should be apparent to those of ordinary skill in the art, and thus, further description thereof will not be provided here.

The binder may strongly have (or help) positive electrode active material particles attach to each other and to attach to a positive electrode current collector. Examples of the binder include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon.

The conducting agent may be used to provide conductivity to the electrodes. Any suitable electron conducting material that does not induce chemical changes in batteries may be used. Examples of the conducting agent include natural graphite, artificial graphite, carbon black, acetylene black, Ketjen black, carbon fibers, and powder or fiber of metals, such as copper (Cu), nickel (Ni), aluminum (Al), or silver (Ag). The conducting agent may include a single conductive material, such as a polyphenylene derivative, or a combination or mixture of at least two conductive materials.

The negative electrode 22 includes a negative electrode current collector, and a negative electrode active material layer disposed on the negative electrode current collector.

The negative electrode current collector may have a thickness of about 3 μm to about 500 μm. The negative electrode current collector is not particularly limited, and may be any suitable material as long as it has a suitable conductivity without causing chemical changes in the battery. Examples of the negative electrode current collector include copper, stainless steel, aluminum, nickel, titanium, sintered carbon, copper or stainless steel that is surface-treated with carbon, nickel, titanium or silver, and aluminum-cadmium alloys. In addition, the negative electrode current collector may be processed to have fine bumps on surfaces thereof so as to enhance binding strength of the negative electrode current collector to an anode active material (a negative electrode active material), and may be used in various suitable forms including films, sheets, foils, nets, porous structures, foams, and non-woven fabrics.

The negative electrode active material layer may include a negative electrode active material, a binder, and, optionally, a conducting agent.

The negative electrode active material includes the above silicon-based negative electrode active material.

The negative electrode active material layer may include other negative electrode active materials generally available in the art, as well as the silicon-based negative electrode active material.

The other negative electrode active material is not particularly limited, and may be any suitable negative electrode active material that is generally used in the art. Examples of the other negative electrode active material include lithium metal, a lithium metal alloy, a transition metal oxide, a material that allows doping or undoping of lithium, and a material that allows reversible intercalation and deintercalation of lithium ions, which may be utilized as a mixture or in combination of at least two thereof.

The lithium metal alloy may be an alloy of lithium with a metal selected from sodium (Na), potassium (K), rubidium (Rb), cesium (Cs), francium (Fr), beryllium (Be), magnesium (Mg), calcium (Ca), strontium (Sr), silicon (Si), antimony or stibium (Sb), lead (Pb), indium (In), zinc (Zn), barium (Ba), radium (Ra), germanium (Ge), aluminum (Al), and tin (Sn).

Non-limiting examples of the transition metal oxide include a tungsten oxide, a molybdenum oxide, a titanium oxide, a lithium titanium oxide, a vanadium oxide, and a lithium vanadium oxide.

Examples of the material that allows doping or undoping of lithium include Sn, SnO₂, a Sn—Y alloy (where Y is an alkali metal, an alkali earth metal, a Group 11 element, a Group 12 element, a Group 13 element, a Group 14 element, a Group 15 element, a Group 16 element, a transition metal, a rare earth element, or a combination or mixture thereof other than Si). Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination or mixture thereof.

The material that allows reversible intercalation and deintercalation of lithium ions may be any suitable carbonaceous negative electrode active material that is generally utilized in lithium batteries. Examples of such carbonaceous materials include crystalline carbon, amorphous carbon, and a mixture thereof. Non-limiting examples of the crystalline carbon include natural graphite, artificial graphite, expanded graphite, graphene, fullerene soot, carbon nanotubes, and carbon fiber. Non-limiting examples of the amorphous carbon include soft carbon (carbon sintered at a low temperature), hard carbon, meso-phase pitch carbides, and sintered corks. The carbonaceous negative electrode active material may be, for example, in spherical, planar, fibrous, tubular, or powder form.

The binder may have (or help) negative electrode active material particles attach to each other well and to attach to a negative electrode current collector. Examples of the binder include, but are not limited to, polyvinyl alcohol, carboxymethyl cellulose, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, SBR, acrylated SBR, epoxy resin, and nylon.

The conducting agent is utilized to provide conductivity to the negative electrode. Any suitable electron conducting material that does not induce chemical changes in batteries may be utilized. Examples of the conducting agent include carbonaceous materials, (such as natural graphite, artificial graphite, carbon black, acetylene black, ketjen black, or carbon fibers); metal-based materials, (such as copper (Cu), nickel (Ni), aluminum (Al), or silver (Ag)) in powder or fiber form; and conductive materials, including conductive polymers, (such as a polyphenylene derivative), and mixtures thereof.

The positive electrode 23 and the negative electrode 22 may be each manufactured by mixing an active material, a conducting agent, and a binder in a solvent to prepare an active material composition, and coating the active material composition on a current collector.

Any suitable method of manufacturing such electrodes generally available in the art, which should be apparent to one of ordinary skill in the art, may be utilized. Thus, further description thereof will not be provided here. The solvent may be N-methyl-pyrrolidone (NMP), acetone, or water, but embodiments are not limited thereto.

The separator 24 may be disposed between the positive electrode 23 and the negative electrode 22, and the separator 24 may be any suitable separator that is generally utilized for lithium batteries. For example, the separator 24 may have low resistance to migration of ions in an electrolyte and have electrolytic solution-retaining ability. The separator 24 may be a single layer or a multi-layer. Examples of the separator 24 include glass fiber, polyester, Teflon, polyethylene, polypropylene, polytetrafluoroethylene (PTFE), and a combination thereof, each of which may be a nonwoven fabric or a woven fabric. The separator 24 may have a pore diameter of about 0.01 μm to about 10 μm and a thickness of about 3 μm to about 100 μm.

The electrolyte is a lithium salt-containing non-aqueous based electrolyte that contains the fluorine-containing alkylene carbonate compound and the silylamide compound.

Suitable usage of the lithium battery may include, but is not limited to, applications in electric vehicles where the lithium battery should be operable at high voltages, high outputs, and high temperatures, in addition to the application in mobile phones or portable computers. The lithium battery may also be configured with an internal combustion engine, fuel cell, and/or super capacitor, for usage in hybrid vehicles. The lithium battery may be applied to electric bicycles, or power tools in which operation at high outputs, high voltages, and high temperatures are needed.

Hereinafter example embodiments will be described in detail with reference to Examples and Comparative Examples. These examples are for illustrative purposes only and are not intended to limit the scope of the inventive concept.

### Example 1

A mixed solvent including ethylene carbonate (EC), ethylmethyl carbonate (EMC) and dimethyl carbonate (DMC) mixed at a volume ratio of about 20:20:60 was combined with LiPF₆ until the concentration of LiPF₆ in the mixed solvent reached 1.5 M. As additives, 10 wt % of monofluoroethylene carbonate and 0.5 wt % of N-methyl-N-(trimethylsilyl)trifluoroacetamide based on the total amount of an electrolyte were added thereto, thereby preparing the electrolyte.

A powder having a composition including LiNi_{0.85}Co_{0.1}Mn_{0.05}O₂, which is a positive electrode active material, a carbon conducting agent (Super-P; Timcal Ltd.), and polyvinylidene fluoride (PVDF) binder were mixed at a weight ratio of about 90:5:5 to form a mixture. In order to control a viscosity of the mixture, a solvent (NMP) was added thereto until the amount of a solid content reached 60 wt %, thereby preparing a positive electrode slurry. The positive electrode slurry was coated to have a thickness of about 40 μm on an aluminum foil having a thickness of 15 μm. The resultant was dried at room temperature, and then dried at 120° C. and pressed, thereby completing the manufacture of a positive electrode.

A Si—Ti—Ni-based Si-alloy (an atomic ratio of Si:Ti:Ni was 68:16:16, and an average particle size thereof was 5 μm), which is a negative electrode active material, LSR7 (available from Hitachi Chemical, a binder including polyamide-imide (PAI) 23 wt % and NMP 77 wt %), which is a binder, and Ketjen Black, which is a conducting agent, were mixed at a ratio of 84:4:8 to form a mixture. Then NMP was added to the mixture to control a viscosity thereof until the amount of a solid content reached 60 wt %, thereby preparing a negative electrode slurry. A copper foil having a current collector having a thickness of about 10 μm was coated with the negative electrode slurry so as to have a thickness of about 40 μm. The resultant was dried at room temperature, and then dried at 120° C. and pressed, thereby completing the manufacture of a negative electrode.

The upper and bottom surfaces of the negative electrode were each covered with a separator. The negative electrode and the positive electrode were wound together into a cylindrical shape. A positive electrode tab and a negative electrode tab were welded to the cylindrical shape, and the welded cylindrical shape was inserted into a cylindrical can and enclosed, thereby manufacturing a half-cell. Then, the electrolyte was injected to the cylindrical can. By cap clipping, a 18650 type (or kind) full cell was manufactured. As a separator, a polyethylene (available from Asahi) member coated with α-Al₂O₃ powder having an average diameter of about 50 nm was used.

### Comparative Example 1

An 18650 type (or kind) full cell was manufactured in substantially the same manner as described with respect to Example 1, except that fluoroethylene carbonate and N-methyl-N-(trimethylsilyl)trifluoroacetamide were not added to the electrolyte as additives.

### Comparative Example 2

A 18650 type (or kind) full cell was manufactured in substantially the same manner as described with respect to Example 1, except that fluoroethylene carbonate was not added to the electrolyte, while N-methyl-N-(trimethylsilyl)trifluoroacetamide was added to the electrolyte as an additive.

### Comparative Example 3

A 18650 type (or kind) full cell was manufactured in substantially the same manner as described with respect to Example 1, except that N-methyl-N-(trimethylsilyl)trifluoroacetamide was not added to the electrolyte, while fluoroethylene carbonate was added to the electrolyte as an additive.

### Evaluation Example 1

### Evaluation of Lifespan Characteristics at Room Temperature

Full cells manufactured as described with respect to Example 1 and Comparative Examples 1 to 3 were each charged at a constant current of 0.2 C rate at about 25° C. until the voltage of the cell reached about 4.2 V, and then, the full cells were each discharged at a constant current of 0.2 C rate at about 25° C. until the voltage of the cell reached about 2.5 V. Subsequently, each of the full cells was charged at a constant current of about 0.5 C rate at about 25° C. until the voltage of the cell reached about 4.2 V, and then the full cells were charged at a constant voltage of about 4.2 V at about 25° C. until the current reached a 0.05 C rate. Afterward, each of the full cells was discharged at a constant current of about 0.5 C until the voltage reached about 2.5 V, thereby completing the formation process.

Subsequently, each of the cylindrical cells (i.e., the full cells) that went through the formation process was charged at a constant current of about 1.6 C rate at about 25° C. until the voltage of the cell reached about 4.2 V, and then charged at a constant voltage of about 4.2 V at about 25° C. until the current reached a 0.05 C rate. Afterward, each of the full cells was discharged at a constant current of about 1.6 C rate until the voltage reached about 2.5 V. The after formation cycle was repeated 300 times.

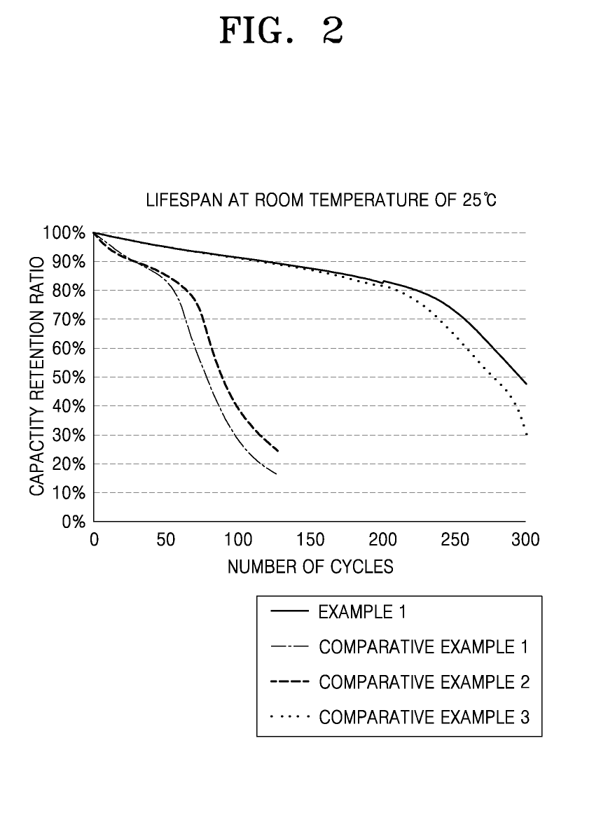

In each full cell, n^{th} cycle discharging capacity and 300^{th} cycle discharging capacity were measured, and a capacity retention ratio of each full cell was calculated according to Equation 1. The results thereof are shown in FIG. 2 and Table 1.

Capacity retention ratio [%]=[n^{th} 1 cycle discharge capacity/1^{st} cycle discharge capacity]×100 Equation 1

TABLE 1

| | 1^{st} cycle | 300^{th} cycle | Capacity retention |
|---|---|---|---|
| | discharging | discharging | ratio at 300^{th} cycle |
| | capacity (mAh) | capacity (mAh) | (%) |
| Example 1 | 2570 | 1205 | 48 |
| Comparative | 2575 | — | — |
| Example 1 | | | |
| Comparative | 2568 | — | — |
| Example 2 | | | |
| Comparative | 2573 | 775 | 29 |
| Example 3 | | | |

In Table 1, the symbol “-” indicates that the lifespan was not measured due to a sharp decline in the lifespan thereof.

As shown in FIG. 2 and Table 1, the lithium secondary battery manufactured as described with respect to Example 1 has improved lifespan characteristics at room temperature as compared to the lithium secondary batteries manufactured as described with respect to Comparative Examples 1 to 3.

### Evaluation Example 2

### Lifespan Characteristics at High Temperatures

As in Evaluation Example 1, the full cells manufactured as described with respect to Example 1 and Comparative Examples 1 to 3 that went through a formation process were charged at a constant current of about 1.5 C rate in a constant-temperature chamber at 45° C. until the voltage thereof reached about 4.25 V (vs. Li). Then, the full cells were discharged at a constant current of about 1.5 C rate at 45° C. until the voltage thereof reached about 2.8 V (vs. Li). This after formation cycle was repeated 500 times.

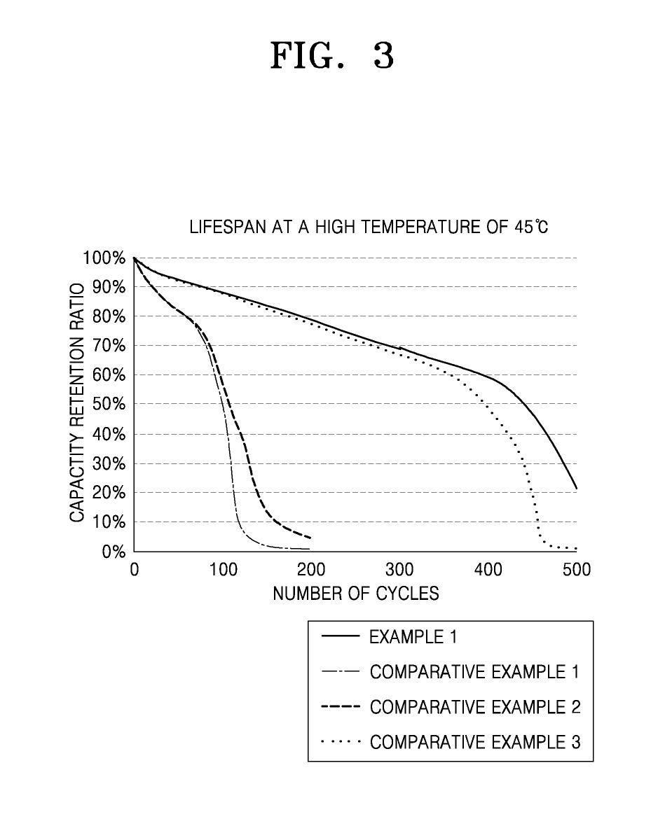

In each full cell, n^{th} cycle discharging capacity and 500^{th} cycle discharging capacity were measured, and a discharge retention ratio of each full cell was calculated according to Equation 1. The results thereof are shown in FIG. 3 and Table 2.

TABLE 2

| | 1^{st} cycle | 500^{th} cycle | Capacity retention |
|---|---|---|---|
| | discharging | discharging | ratio at 500^{th} cycle |
| | capacity (mAh) | capacity (mAh) | (%) |
| Example 1 | 2558 | 556 | 22 |
| Comparative | 2561 | — | — |
| Example 1 | | | |
| Comparative | 2550 | — | — |
| Example 2 | | | |
| Comparative | 2563 | 29 | — |
| Example 3 | | | |

In Table 2, the symbol “-” indicates that the lifespan was not measured due to a sharp decline in the lifespan thereof.

As shown in FIG. 3 and Table 2, the lithium secondary battery manufactured as described with respect to Example 1 has improved lifespan characteristics at room temperature as compared to the lithium secondary batteries manufactured as described with respect to Comparative Examples 1 to 3.

Based on the results above, it was determined that when the fluorine-containing alkylene carbonate compound and the silylamide compound were added as additives to an electrolyte of a lithium secondary battery, the high-capacity lithium secondary battery using a silicon-based negative electrode may have improved lifespan characteristics at high temperatures as well as at room temperature.

As described above, according to one or more of the above example embodiments, the lithium secondary battery may have improved lifespan characteristics at room temperature and high temperatures.

It should be understood that the example embodiments described herein should be considered in a descriptive sense only and not for purposes of limitation. Descriptions of features or aspects within each example embodiment should typically be considered as available for other similar features or aspects in other example embodiments.

While one or more example embodiments have been described herein with reference to the figures, it will be understood by those of ordinary skill in the art that various changes in form and details may be made herein without departing from the spirit and scope of the following claims, and equivalents thereof.

What is claimed is:

1. A lithium secondary battery comprising:
a positive electrode comprising a lithium nickel composite oxide;
a negative electrode comprising a silicon-based negative electrode active material; and
an electrolyte between the positive electrode and the negative electrode, the electrolyte comprising a fluorine-containing alkylene carbonate compound represented by Formula 1 and a silylamide compound represented by Formula 2: 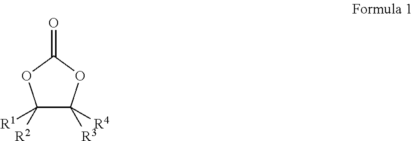
wherein in Formula 1,
R¹, R², R³, and R⁴ are each independently selected from a hydrogen atom, a fluorine atom, a C₁-C₆ alkyl group substituted or unsubstituted with a fluorine atom, a C₂-C₆ alkenyl group substituted or unsubstituted with a fluorine atom, and a C₂-C₆ alkynyl group substituted or unsubstituted with a fluorine atom, provided that at least one of R¹, R², R³, and R⁴ is a fluorine atom or a group substituted with at least one fluorine atom, 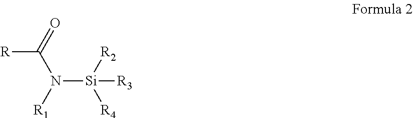
wherein in Formula 2,
R and R₁ are each independently selected from a hydrogen atom, a hydroxy group, a cyano group, —C(═O)Rₐ, —C(═O)ORₐ, —OC(═O)Rₐ, —OC(═O)(ORₐ), —NR_{b}R_{c}, a substituted or unsubstituted C₁-C₆ alkyl group, a substituted or unsubstituted C₁-C₆ alkoxy group, a substituted or unsubstituted C₂-C₆ alkenyl group, a substituted or unsubstituted C₂-C₆ alkynyl group, a substituted or unsubstituted C₃-C₁₂ cycloalkyl group, a substituted or unsubstituted C₆-C₂₀ aryl group, a substituted or unsubstituted C₆-C₂₀ aryloxy group, a substituted or unsubstituted C₆-C₂₀ heteroaryl group, and —ORₓ, wherein, Rₓ is a C₁-C₆ alkyl group or a C₆-C₂₀ aryl group;
R₂, R₃, and R₄ are each independently selected from a cyano group, —C(═O)Rₐ, —C(═O)ORₐ, —OC(═O)Rₐ, —OC(═O)(ORₐ), —NR_{b}R_{c}, a substituted or unsubstituted C₁-C₁₂ alkyl group, a substituted or unsubstituted C₁-C₁₂ alkoxy group, a substituted or unsubstituted C₂-C₁₂ alkenyl group, a substituted or unsubstituted C₂-C₁₂ alkynyl group, a substituted or unsubstituted C₃-C₁₂ cycloalkyl group, a substituted or unsubstituted C₆-C₁₂ aryl group, a substituted or unsubstituted C₆-C₁₂ aryloxy group, a substituted or unsubstituted C₆-C₁₂ heteroaryl group, and —OR_{y}, wherein, R_{y} is a C₁-C₁₂ alkyl group or a C₆-C₁₂ aryl group;
wherein Rₐ is selected from a hydrogen atom, an unsubstituted C₁-C₁₀ alkyl group, a C₁-C₁₀ alkyl group substituted with a halogen atom, an unsubstituted C₆-C₁₂ aryl group, a C₆-C₁₂ aryl group substituted with a halogen atom, an unsubstituted C₆-C₁₂ heteroaryl group, and a C₆-C₁₂ heteroaryl group substituted with a halogen atom; and
R_{b} and R_{c} are each independently selected from a hydrogen atom, an unsubstituted C₁-C₁₀ alkyl group, a C₁-C₁₀ alkyl group substituted with a halogen atom, unsubstituted C₂-C₁₀ alkenyl group, a C₂-C₁₀ alkenyl group substituted with a halogen atom, an unsubstituted C₃-C₁₂ cycloalkyl group, a C₃-C₁₂ cycloalkyl group substituted with a halogen atom, an unsubstituted C₆-C₁₂ aryl group, a C₆-C₁₂ aryl group substituted with a halogen atom, an unsubstituted C₆-C₁₂ heteroaryl group, a C₆-C₁₂ heteroaryl group substituted with a halogen atom, and —Si(R_{d})₃, wherein, R_{d} is a C₁-C₁₀ alkyl group.

2. The lithium secondary battery of claim 1, wherein in Formula 1, R¹, R², R³, and R⁴ satisfy at least one of (i) to (iii):
(i) R¹, R², R³, and R⁴ are selected from a hydrogen atom or a fluorine atom, provided that at least one of R¹, R², R³, and R⁴ is a fluorine atom;
(ii) R¹ is a C₁-C₃ alkyl group or a C₁-C₃ alkyl group substituted with at least one fluorine atom; and R², R³, and R⁴ are each a hydrogen atom or a fluorine atom, provided that at least one of R², R³, and R⁴ is a fluorine atom, or R¹ is a C₁-C₃ alkyl group substituted with at least one fluorine atom; and
(iii) R¹ and R² are each a C₁-C₃ alkyl group or a C₁-C₃ alkyl group substituted with at least one fluorine atom; and R³ and R⁴ are each a hydrogen atom or a fluorine atom, provided that at least one of R³ and R⁴ is a fluorine atom, or at least one of R¹ and R² is a C₁-C₃ alkyl group substituted with at least one fluorine atom.

3. The lithium secondary battery of claim 1, wherein the fluorine-containing alkylene carbonate compound is selected from monofluoroethylene carbonate, cis-4,5-difluoroethylene carbonate, trans-4,5-difluoroethylene carbonate, 4,4-difluoroethylene carbonate, trifluoroethylene carbonate, tetrafluoroethylene carbonate, 4-fluoro-4-methyl-1,3-dioxolan-2-one, 4-fluoro-4-ethyl-1,3-dioxolan-2-one, 4-fluoro-5-methyl-1,3-dioxolan-2-one, 4-ethyl-4-fluoro-1,3-dioxolan-2-one, 5-ethyl-4-fluoro-4-ethyl-1,3-dioxolan-2-one, 4-fluoro-4,5-dimethyl-1,3-dioxolan-2-one, 4,5-difluoro-4-methyl-1,3-dioxolan-2-one, 4,4,5-trifluoro-5-methyl-1,3-dioxolan-2-one, 4-fluoro-5-(1-fluoroethyl)-1,3-dioxolan-2-one, 4-fluoro-5-(2-fluoroethyl)-1,3-dioxolan-2-one, 4-trifluoromethyl-4-methyl-1,3-dioxolan-2-one, 4-trifluoromethyl-4-methyl-5-fluoro-1,3-dioxolan-2-one, 4-(2,2,2-trifluoroethyl)-4-methyl-5-fluoro-1,3-dioxolan-2-one, and a mixture thereof.

4. The lithium secondary battery of claim 1, wherein an amount of the fluorine-containing alkylene carbonate compound in the electrolyte is in a range of about 0.1 wt % to about 20 wt % based on a total weight of the electrolyte.

5. The lithium secondary battery of claim 1, wherein in Formula 2,
R and R₁ are each independently selected from a C₁-C₆ alkyl group and a C₁-C₆ alkyl group substituted with at least one halogen atom; and
R₂, R₃, and R₄ are each independently selected from a C₁-C₁₂ alkyl group, a C₁-C₁₂ alkyl group substituted with at least one halogen atom, a C₂-C₁₂ alkenyl group, and a C₂-C₁₂ alkenyl group substituted with at least one halogen atom.

6. The lithium secondary battery of claim 1, wherein the silylamide compound represented by Formula 2 comprises at least one selected from Compounds 1 to 4 below:

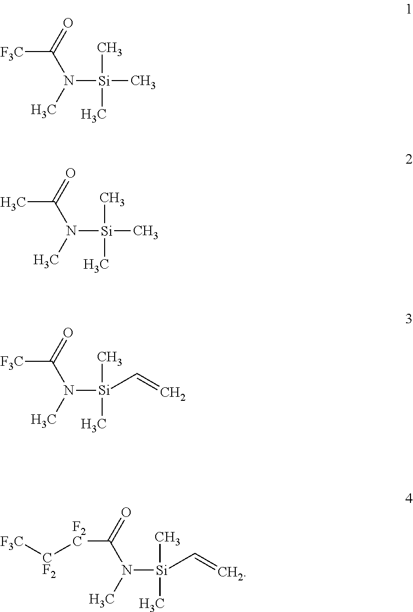

7. The lithium secondary battery of claim 1, wherein an amount of the silylamide compound in the electrolyte is in a range of about 0.01 wt % to about 10 wt % based on a total weight of the electrolyte.

8. The lithium secondary battery of claim 1, wherein the electrolyte comprises at least one additive selected from LiBF₄, tris(trimethylsilyl)borate (TMSB), tris(trimethylsilyl)phosphate (TMSPa), lithium bis(oxalato)borate (LiBOB), lithium difluoro(oxalato)borate (LiFOB), vinyl carbonate (VC), propane sultone (PS), succinonitrile (SN), a silane compound, a silazane compound, and a mixture thereof.

9. The lithium secondary battery of claim 8, wherein an amount of the additive in the electrolyte is in a range of about 0.01 wt % to about 10 wt % based on a total amount of the electrolyte.

10. The lithium secondary battery of claim 1, wherein the silicon-based negative electrode active material comprises at least one selected from Si, SiOₓ (0<x<2), a Si—Z alloy, and a combination thereof, where Z is an alkali metal, an alkali earth metal, a Group 13 to 16 element, a transition metal, a rare earth element, or a combination thereof, excluding Si.

11. The lithium secondary battery of claim 1, wherein the lithium nickel composite oxide is represented by Formula 3:
Liₐ(NiₓM′_{y}M″_{z})O₂ Formula 3
wherein in Formula 3, M′ is at least one element selected from Co, Mn, Ni, Al, Mg, and Ti, M″ is at least one element selected from Ca, Mg, Al, Ti, Sr, Fe, Co, Mn, Ni, Cu, Zn, Y, Zr, Nb, B, and a combination thereof, 0<a≦1, 0.7≦x≦1, 0≦y≦0.3, 0≦z≦0.3, and x+y+z=1.

12. The lithium secondary battery of claim 1, wherein the lithium nickel composite oxide comprises at least one compound represented by one of Formula 4 or Formula 5:
Liₐ(NiₓCo_{y}Mn_{z})O₂ Formula 4
wherein in Formula 4, 0<a≦1, 0.7≦x≦1, 0≦y≦0.3, 0≦z≦0.3, and x+y+z=1
Liₐ(NiₓCo_{y}Al_{z})O₂ Formula 5
wherein in Formula 5, 0<a≦1, 0.7≦x≦1, 0≦y≦0.3, 0≦z≦0.3, and x+y+z=1.
